(19) United States
(12) Patent Application Publication
(10) Pub. No.: US 2011/0275346 A1
(43) Pub. Date: Nov. 10, 2011

(54) METHOD AND APPARATUS FOR RULE TRIGGERED MOBILE ADVERTISING

(76) Inventors: Jeffrey B. Fraser, Newton, MA (US); Kenneth W. Sonberg, Andover, MA (US); Kishore Rajasekharuni, Hyderabad (IN); Arun Kumar, Hyderabad (IN)

(21) Appl. No.: 13/101,734

(22) Filed: May 5, 2011

Related U.S. Application Data
(60) Provisional application No. 61/331,943, filed on May 6, 2010.

(51) Int. Cl. H04M 11/00

(52) U.S. Cl. 455/408

(57) ABSTRACT

An advertising subsidized communication service is provided that can be utilized by eligible subscribers in instances designated by mobile operators or advertisers. An eligible subscriber that meets certain criteria, such as having a low pre-paid balance, can opt-in to an advertising subsidized service initiated through an SCP proxy for the advertising service platform. The subscriber receives advertising through selected channels, such as voice injection, text messaging or other media, which advertising subsidizes subscriber communication service. The subsidized service may be limited in some regard to number of calls, call duration or incoming calls, as examples. The subscriber may be automatically opted-out of the subsidized service upon payment being applied to a pre-paid for post-paid service account. The opt-in process for subsidized service occurs in real-time and may be prompted through a number of channels, such as voice or text messages.

### CROSS REFERENCE TO RELATED APPLICATIONS

This application claims the benefit of U.S. Provisional Application No. 61/331,943, filed on May 6, 2010, the disclosure of which is hereby incorporated herein by reference.

### STATEMENT REGARDING FEDERALLY SPONSORED RESEARCH OR DEVELOPMENT

(Not Applicable)

### BACKGROUND OF THE INVENTION

The presently disclosed systems and methods relate generally to advertising supported communication service, and relate more particularly to implementing communication service with optional advertising subsidized communication service.

Communication services, such as wireless telephone service and long distance calling service can be purchased on a pre-paid basis. Often, wireless communication devices such as mobile telephones can be purchased that include a certain amount of pre-paid communication service, for example. Typically, when the pre-paid amount of communication services is used up, a user can replenish an account associated with the pre-paid communication services.

Wireless communication service is also available on a monthly payment schedule, where the subscriber has an account with a carrier for a chosen wireless communication device, such as a mobile telephone. These types of services are sometimes referred to as post-paid communication service, since payment is usually provided after the services are used. Post-paid communication services may also have a threshold associated with the account, where if payment on the account is not received after a certain period of time, or after a certain amount of credit has been extended, or a given balance has been reached on the account, the account may be disabled. Once the account is replenished, service is typically reinstated. In either the pre-paid or post-paid billing arrangement, the thresholds are used to permit or prevent communication device usage. The thresholds, or logic associated with preventing or permitting a communication device to be usable are typically referred to as “business rules.” Business rules are typically set by a communication service provider, device provider or other entities concerned with the communication services.

When the relevant criteria for an account associated with a communication device crosses a given threshold, resulting in the device being unusable, the ability of the user to effectively use the communication device can be interrupted. Moreover, the loss of communication service or difficulty for a subscriber meeting the various thresholds can result in loss of the subscriber, contributing to undesirable churn.

### BRIEF SUMMARY OF THE INVENTION

In accordance with the disclosed systems and methods, pre-paid and/or post-paid communication services can be supplemented with advertising revenue supported services. The user can choose to enable a communication device to receive advertising, in exchange for maintaining communication services with the device, for example.

According to one aspect, the user is prompted with the option of receiving advertising revenue supported services when the balance of an account associated with a wireless communication device passes a certain threshold. The threshold may be set in accordance with a business rule of the communication services provider or communication device manufacturer, for example.

According to one aspect, a user that opts to use the advertising revenue supported service has advertising provided to the communication device or to a selected address or destination. The advertising can be provided in one or more forms before, during or after a particular instance of using the communication device.

According to another aspect, a system for implementing advertising subsidized communication is provided. An advertising delivery management system makes ads available for delivery to an opted-in subscriber or user, where a mobile operator may permit the system to provide advertising to the subscriber or user when certain account-related criteria is met. Components of the mobile operator network cause a call by the subscriber to be connected or noted to system resources that can provide ads to the caller communication device. As used herein, the term “call” refers generally to any type of communication or message, whether initiated by a user or system component, and includes communications via a voice channel, data channel, call signaling channel or text messaging channel. The advertising used to support subsidized communication may also be delivered via any of these communication channels. According to this aspect, the mobile operator network is responsible for call handling and session control.

According to another aspect, the disclosed systems and methods may be implemented in coordination between several parties, including the mobile operator. The mobile operator may provide call handling infrastructure, including a service control point (SCP) for, among other functions, intercepting calls and providing network messaging to implement an advertising subsidized communication service. The mobile operator or a party other than the mobile operator may provide one or more of pre-paid services, billing services and/or ad-subsidized services, independently or in coordination with each other. Alternately, pre-paid services and billing services may be provided by one party, which may be the mobile operator, while ad-subsidized services are provided by another party or vendor.

According to another aspect, upon replenishing an account balance beyond a given threshold, as may be indicated by business rules associated with the pre-paid communication services, advertising revenue support for communication services can be discontinued or continued as desired by the user or indicated by the business rules associated with the pre-paid communication services.

According to another aspect, an SCP proxy is provided to intercept calls and provide advertising to eligible subscribers. The SCP proxy permits subscribers to opt into an advertising supported communication service, without necessarily being a primary SCP. The SCP proxy is positioned in an intelligent network as an alternative call handling infrastructure to permit a Mobile Advertising Platform (MAP) to intercept or manage calls from mobile operators. The calls may be routed through a Mobile Switching Center (MSC) and are not necessarily designated to be handled by a primary pre-paid SCP provider. That is, the SCP proxy can operate to intercept or manage calls (and optionally play advertisements) without replacing the pre-existing agreements and signaling between a mobile operator and the mobile operator's primary pre-paid SCP service provider.

Accordingly to another aspect, systems and methods are provided to permit subscribers to opt-in to an advertising supported communication service. In addition, systems and methods are provided to permit subscriber opt-out of advertising supported communication services. While a subscriber is opted-in, the present disclosure provides for delivery of advertising over one or more media channels for pre-paid or post-paid subscribers to continue to receive communication services when an account-related threshold has been crossed in accordance with business logic provisioned in the mobile operator's communication services platform and/or the advertising platform. The disclosed systems and methods provide real-time call control to implement an advertising platform and deliver advertising to subscribers in exchange for extending communication services to the subscriber.

### BRIEF DESCRIPTION OF THE SEVERAL VIEWS OF THE DRAWINGS

The presently disclosed systems and methods are described below in greater detail with reference to the accompanying drawings, in which:

FIG. 1 is a block diagram illustrating a logical architecture in accordance with an embodiment of the disclosed systems and methods;

FIG. 2 is a block diagram illustrating a physical architecture in accordance with an embodiment of the disclosed systems and methods;

FIG. 3 is a process flow diagram illustrating an opt-in process;

FIG. 4 is a process flow diagram illustrating advertising delivery in accordance with an embodiment of the present disclosure; and

FIG. 5 is a process flow diagram illustrating an opt-out process.

### DETAILED DESCRIPTION OF THE INVENTION

This application claims the benefit of U.S. provisional application No. 61/331,943, filed on May 6, 2010, the entire disclosure of which is hereby incorporated herein by reference.

The present disclosure provides for advertising supported communication services for use with pre-paid or post-paid subscribers, independent of whether the service provider has a services agreement for primary SCP function in place with a wireless carrier or other service operator. In the following discussion of the disclosed systems and methods, a number of acronyms are used, which are listed here for convenience of reference.

MAP: A Mobile Advertising Platform that enables mobile network operators to manage advertising partners and allow those partners to schedule advertisements and coupons for delivery to subscribers using a variety of communication channels.

WIN: A Wireless Intelligent Network applies intelligent network solutions to CDMA wireless networks.

CAMEL: Customized Applications for Mobile Networks Enhanced Logic are a set of standards for defining services beyond standard GSM services including intelligent network solutions (IN) for GSM wireless networks.

IN: Intelligent Networking, can be implemented on GSM or CDMA networks. IN can use CAMEL or WIN or other protocols as signaling protocols.

ISUP: ISDN User Part that is part of the SS7 call signaling protocol for call setup in PSTN's.

SIP: The Session Initiation Protocol provides call signaling over IP networks based on a session paradigm.

USSD: Unstructured Supplementary Service Data is a protocol used by GSM mobile communication devices to communicate with service operator computers.

GSM: Global System for Mobile communications provides digital signaling and voice channel communication as part of a global standard.

SMS: Short Message Service is a form of text messaging often used on mobile communication devices.

MMS: Multimedia Messaging Service provides a standard for communicating multimedia content messages typically on mobile communication devices.

CDMA: Code Division Multiple Access is a radio modulation communication technique.

MA: Mobile Advertising services provided to subscribers using mobile communication devices.

LBSMAP: A Low Balance Subsidy MAP provides advertising to mobile communication devices under certain circumstances related to a low credit or account imbalance.

API: An Application Programming Interface provides specified access to a software program to utilize program functionality.

IVR: Interactive Voice Response permits a user to interact with a computer using voice messages and DTMF keypad inputs.

DTMF: Dual Tone Multi-Frequency signaling is a signaling system for communicating keypad inputs as tones in a telecommunication system.

MSC: A Mobile Switching Center switches or routes mobile communication messages, as well as performing call setup and handoff operations.

SMSC: A Short Message Service Center is a network element in mobile communication networks that processes SMS messages.

MMSC: A Multimedia Mobile Switching Center is typically implemented as a store and forward server for processing multimedia messages in a mobile telecommunication network.

SRF/IP: A Specialized Resource Function/Intelligent Peripheral provides services for voice injection under MSC session control.

RBT: Ring-Back Tone typically generated by the switching system in a communication network to indicate status of a called party's line.

ESME: The External Short Message Entity provides application functionality to connect to an SMSC to process SMS messages.

XML: EXtensible Markup Language provides a set of rules for encoding documents using textual data format.

SMPP: The Short Message Peer-to-Peer protocol permits SMS messages to be exchanged between SMS peer entities.

P2P: Peer-to-Peer networking is based on a distributed architecture that can distribute workload among a number of peers in the network.

SS7: Signaling System #7 is a signaling protocol for PSTN networks to implement call setup and control.

MT: Mobile Terminated SMS message or voice call that has a mobile communication device as a destination address.

MM7: Multimedia Messaging 7 provides an interface between an MMSC and a VAS provider.

VAS: Value Added Service, such as ring tone or game or other application that can be downloaded to a mobile device.

HLR: The Home Location Register is a database that provides details about a mobile telephone user in a GSM network, and can include user location data.

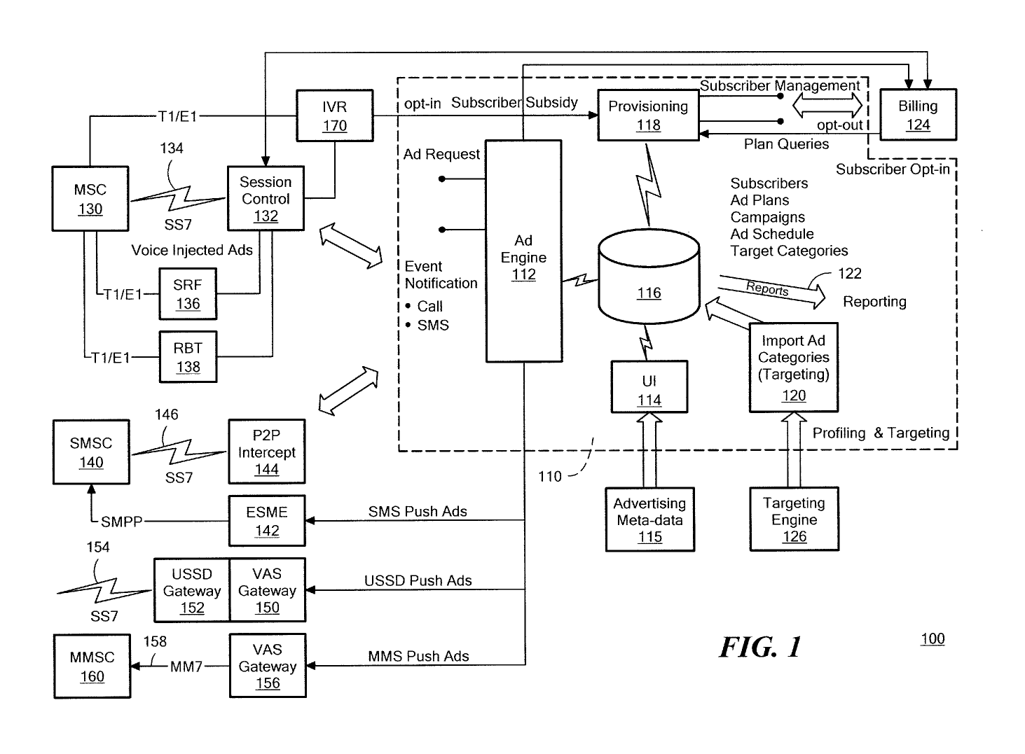

Referring now to FIG. 1, a MAP system 100 for providing mobile advertising is illustrated. MAP system 100 enables mobile network operators to manage advertising provided to subscribers or users of mobile communication systems. The advertising can be provided on a number of different channels, as specified or selected in a plan that is associated with a subscriber or user account. A MAP platform 110 illustrates components of a MAP system, including ad engine 112, a user interface (UI) 114, a database 116, a component for provisioning 118 and a component for ad targeting 120. Map platform 110 provides a reporting output through reports 122, which are drawn from data housed in database 116. Database 116 houses such information as subscriber or user profiles, advertising plans, advertising campaigns, advertising scheduling and target categories, as well as the uploaded ads themselves and ad meta-data.

Ad engine 112 may be implemented on a computer as a server, and provides an interface to various communication system components for advertising delivery. Ad engine 112 can be queried to determine if there is an ad to play for a given event, such as a subscriber placing a call, the type of ad and an ad delivery channel. Ad engine 112 accesses database 116 to obtain the ad-related information, including the ad and ad delivery channel. Database 116 can be configured prior to the call through UI 114 and targeting engine 126 to develop an advertising profile that can be applied to a given subscriber or user for a particular call. For example, prior to an ad-subsidized call being placed, an administrator can upload ads and ad meta-data to database 116 through UI 114, and associate the ads and meta-data with an advertising profile using targeting engine 126 and targeting 120 to establish advertising relevance and priority for a given user profile. Ad engine 112 can access the advertising profile and select an ad for the subscriber or user based on the user profile associated with the subscriber or user. Ad engine 112 also supports APIs that are exposed to communication network components to permit ad delivery and provide feedback for network event status, such as a voice call ending, for example.

User interface 114 provides an access point for administering and maintaining MAP platform 110, as well as providing access for advertisers to define advertising campaigns, upload ad content including ad meta data 115 and schedule ad delivery. Provisioning 118 in MAP platform 110 exposes APIs that are accessible to external communication network systems or components to permit subscribers or users to opt into an MA service and begin receiving mobile advertisements. Provisioning 118 interacts with external components to provide rewards for opting into and accepting advertising programs, which rewards can be implemented as discounts or subsidies associated with a communication services user account. The user account may be resident in MAP platform 110, may be a pre-paid account and may interact with billing system 124.

Account information for a user or subscriber provided by billing system 124 can contribute to subscriber management through provisioning 118, where opted-in users of advertising subsidized communication services may have an associated profile stored in database 116. Billing system 124 may also provide indications of an advertising subsidized communication service plan, where the type of service that is subsidized by advertising can be set for a given user and associated with a user account. Advertising subsidized plans can also be characterized with input from targeting engine 126, which can act as a resource for specifications for advertising campaigns that may help to direct how an advertising subsidized plan is to be implemented. Targeting engine 126 and billing system 124 permit profile information for advertising and subscribers to be imported into MAP platform 110 to enable ads to be targeted to specific demographics within the subscriber base, such as by building advertising profiles in database 116, as discussed above. Targeting 120 can also help with advertising campaigns by providing data mining resources and information related to an ongoing or previous ad campaign, for example.

The delivery of advertising to a communication device may take place in a number of different forms and through a number of different channels. For example, MAP platform 110 can provide voice injected advertising using WIN, Camel, ISUP or SIP call control in conjunction with an MSC 130. MSC 130 is in communication with session control 132 through an SS7 call signaling link 134. Session control 132 interacts with billing system 124 to help determine advertising subsidized communication service implementation, such as may be indicated by an account balance or other business logic that permits the establishment of a threshold for subscriber service cutoff.

Session control 132 is able to direct calls interacting with MSC 130 to SRF/IP 136, where a voice message can be played to the subscriber or user. It should be understood that while SRF/IP 136 is an example of a component that is used in GSM networks in accordance with the present disclosure, an Intelligent Peripheral may be used in the case of CDMA networks to play a voice message to the subscriber or user. The voice message can operate as the voice injected advertising, and once the voice message is delivered, session control 132 can resume call processing in conjunction with MSC 130.

An RBT platform 138 may also be used to deliver voice ads to calling parties without suspending call processing. The voice advertisement can be played until a called party answers, at which point the voice ad from RBT platform 138 is discontinued, and session control 132 permits the call to be connected and to proceed. RBT platform 138 can implement both standard and reverse RBT advertisements. Standard RBT advertisements may originate from the LBSMAP and be directed to the calling party who is not an opted-in subscriber and who may be the customer of either the same or a different mobile operator than that of an LBSMAP opted-in subscriber. Reverse RBT advertisements are those for which the opted-in LBSMAP caller hears an RBT message that originates from an LBSMAP under the control of the caller's mobile operator.

MAP platform 110 can also deliver advertising through text messaging, which can be implemented through a number of different text channels. For example, SMSC 140 provides SMS push messages to a user through ESME 142. MAP platform 110 can initiate an SMS push ad by sending an XML command to ESME 142, which provides the text ad to the mobile operator SMSC 140 using SMPP.

Another channel for text messages is through a P2P intercept agent 144, which interacts with SMSC 140 through an SS7 call signaling link 146. According to an exemplary embodiment, P2P intercept agent 144 can intercept MT SMS messages and send a follow-up text message to the destination address associated with the SMS message. Alternatively, or in addition, P2P intercept agent 144 can insert advertising text in empty space that is available in the intercepted SMS message. The SMS message, with the inserted advertising text, is delivered to the original destination party through SMSC 140. In each of these embodiments, P2P intercept agent 144 provides a query to MAP platform 110 to determine the text content that is to be inserted into or delivered with an SMS message for delivery to the destination party.

Text messaging advertisements can also be pushed to users using USSD in GSM networks. MAP platform 110 provides commands to VAS gateway 150, which in combination with USSD Gateway 152 provides USSD messages to the SS7 call signaling network through link 154. In addition, MAP platform 110 can provide commands to a VAS gateway 156 to implement MMS push ads through an MM7 interface 158, in conjunction with a mobile operator MMSC 160 that can deliver MMS push adds to the designated subscribers or users.

MAP platform 110 provides advertising to mobile users, such as by voice injection, using a standard WIN or CAMEL or SIP or ISUP session control. MAP platform 110 can interact with billing system 124 in real-time to indicate the fulfillment of advertising delivery. Text messages are also included in billing system 124, which interacts with MAP platform 110 through APIs provided through provisioning 118. When a subscriber or user is put on a plan that involves mobile advertising, such as when they opt-in to an advertising subsidized communication service, a subscriber record may be created in database 116, which record is associated with a mobile advertising plan. Billing system 124 interacts with session control 132 to help determine when mobile advertising is to be provided to a given user. Billing system 124 can provide a “hint” to session control 132 regarding a mobile advertising plan when a user is to be provided with mobile advertising. By providing such a hint, billing system 124 can supply information to session control 132 to avoid or prevent session control 132 from querying MAP platform 110 to obtain mobile advertising information that may be redundant or unnecessary. In general, however, session control 132 queries MAP platform 110 to determine an ad to be provided to a user and a delivery channel for the ad.

An exemplary embodiment of a process for implementing an advertising subsidized communication service using MAP system 100 begins with a subscriber A, which has opted-in to the advertising subsidized service, placing a call to a user B. The call from subscriber A is received at MSC 130, which triggers a message to an SCP that provides session control 132. The SCP, through session control 132, requests a connection to SRF/IP 136, which may be implemented on a pre-paid basis. SRF/IP 136 provides subscriber A with a voice message to indicate that subscriber A has a low account balance, for example, and that the LBS service is potentially engaged. Session control 132 returns a message to ad engine 112 after the announcement is made to determine whether an ad is to be provided to subscriber A. If the subscriber is not already opted-in into the LBS Service, SRF/IP 136 can prompt the subscriber to opt-in to the LBS Service. If it is determined that subscriber A is eligible to make advertising subsidized calls, session control 132 sends a request to MSC 130, followed by a request sent to MSC 130 to connect subscriber A to SRF/IP 136. MSC 130 responds to the request by routing the call to SRF/IP 136. SRF/IP 136 interacts with ad engine 112 and session control 132 to select and deliver an advertisement to subscriber A over a delivery channel in accordance with a selected ad plan. The advertisement is delivered to subscriber A, after which session control 132 sends a “disconnect from SRF” request and a “connect to user B” request to MSC 130. MSC 130 receives the requests and connects subscriber A to user B. Session control 132 may then monitor the call, for example to examine a maximum call duration parameter, as may be imposed by the ad plan settings. Session control 132 tears down the call from subscriber A to user B at the end of the call or, for example, once a predetermined call duration is reached. Session control 132 may take other steps such as decrementing a call counter maintained in a profile for subscriber A in database 116.

MAP platform 110 can operate with a pre-paid database (not shown) as part of billing system 124 to implement an LBSMAP. LBSMAP provides an integrated advertising subsidized communication service in conjunction with pre-paid services that a user or subscriber can opt into upon being prompted. According to one exemplary embodiment, a pre-paid user account includes a profile with an indication that the user is enabled for LBS services. When the user account reaches a predetermined threshold, such as having less than a dollar remaining of pre-paid services, MAP platform 110 receives a signal through provisioning 118 to initiate a prompt to the user. The user prompt may be provided through an IVR 170 that operates with session control 132 and MSC 130 to inform the user that there are insufficient funds to initiate a desired telephone call. IVR 170 can further prompt the user that they are eligible to continue to receive pre-paid communication services, potentially under some constraint such as diminished or time-limited service. The user may also be prompted to opt-in to the advertising subsidized communication service by signaling IVR 170 with a prescribed response, such as by keying in a particular sequence indicated by IVR 170. Once the user opts-in to the subsidized communication service, they receive advertisements in accordance with an ad plan configured in database 116.

A number of variations for permitting a user to opt-in to the advertising subsidized communication service may be implemented. For example, the user account may be preset to be automatically opted-in to subsidized service, or maybe preset to implicitly opt-in to subsidized service of the occurrence of some event, such as upon reaching a predetermined low balance threshold. The user account may be set to omit presets related to LBS or advertising subsidized communication services, so that the user is prompted to opt-in when a particular account balance threshold is reached.

The ad plans for subsidizing communication services are stored in database 116 and managed through user interface 114 to direct particular ad plans to particular users. For example, ad plans may be directed to provide voice injection or text messaging advertising, or some combination of these. Ad plans may indicate that ads should be delivered to the communication device of the user or to a device associated with a person calling or texting the user. An ad plan may also indicate that normal service may be provided, or that the service may be degraded to some extent, such as by permitting incoming calls to be delivered but preventing outgoing calls. An ad plan may also indicate a point in a call flow process where a voice ad may be played.

The user or subscriber may opt-out of advertising subsidized service in a number of ways, including by recharging their pre-paid account or by discontinuing service. MAP platform 110 retains the context of the user or subscriber and can maintain a profile database for users that take advantage of subsidized services. The profile database, stored in database 116, for example, may be used for purposes such as tracking patterns of LBS usage or permitting the application of different ad plans. For example, a mobile operator may implement business rules to control the number of times that LBS is used according to some criteria. The mobile operator may implement a business rule to permit a user to opt-in to advertising subsidized service for three consecutive days, twice per month or if a minimum recharge amount is provided to the account, as examples.

The above-described logical architecture and operations are provided in the context of pre-paid services that can be extended with advertising subsidization. However, the disclosed systems and methods can be applied to post-paid subscribers or users as well. According to an exemplary embodiment, a post-paid user may use services at a greater rate or beyond a given credit threshold that is established by the mobile operator. In such an instance, the user can be treated as a pre-paid subscriber that has exhausted their account, or that has reached some predetermined threshold as described above in relation to pre-paid subscribers. When the post-paid user is treated as a pre-paid subscriber, they can be straightforwardly integrated into the pre-paid system provided through MAP platform 110 to receive advertizing subsidized service. Treatment of the post-paid user as a pre-paid subscriber can be achieved by changing the profile of the user in the HLR. Once indicated as a pre-paid subscriber, the user can take advantage of LBS services to continue use of a communication device. The post-paid subscriber or user can opt-out of the advertising subsidized service by discontinuing service or making payments on their post-paid account, for example.

Provisioning 118, as described above, offers a number of APIs to permit interaction with various systems and components that are external to MAP platform 110. For example, provisioning 118 offers an opt-in and an opt-out API for implementing the LBSMAP system. A subscriber or user that is permitted to access the LBS service is provided with an explicit or implicit opt-in feature to receive advertising subsidized service. The opt-in feature may be presented to a user through IVR 170, and upon being activated may invoke an opt-in API through provisioning 118 to activate the user in the LBS service. The opt-in API sets up the user with an ad plan and manages their experience within MAP platform 110. When the user is deactivated or disassociated with the ad plan, as may be determined by a mobile operator criteria, MAP platform 110 causes the opt-out API to be invoked, as may be configured through a customer care user interface. For example, a user profile may be modified to remove LBS service eligibility, upon which the user may be opted-out, and may not be prompted to opt-in with respect to future low balance situations. Other APIs that may be implemented in provisioning 118 are listed below in Table 1.

TABLE 1

| API | Description |
|---|---|
| AdQuery | Invoked by client software to determine: |
| | (1) Is a subscriber opted in to MAP service? |
| | (2) (Assuming 1 is yes) Is the subscriber to |
| | receive an ad via a specific channel |
| | (identified by the client)? |
| | (3) What is to be delivered (assuming 2 is yes) |
| EndCall | Invoked by Session Control or other call |
| | control elements to indicate that a call has |
| | been terminated by one of the parties. |
| | Ad engine 112 can specify in the response to an |
| | AdQuery that it wants to know when the call is |
| | over. For example, an ad can be delivered upon |
| | call end as indicated in the subscriber Ad |
| | Plan. |
| OptIn | Invoked by billing system 124 or an external |
| | application to opt a subscriber into the LBSMAP |
| | service. An ad plan can be specified at this |
| | time. If no ad plan is specified, a default |
| | can be used. |
| OptOut | Invoked by billing system 124 or an external |
| | application to opt a subscriber out of the |
| | LBSMAP service. |
| PlanQuery | Invoked by billing system 124 to retrieve a |
| | description of the subscriber's ad plan for |
| | display. |

External applications may include opt-in agents that use the APIs provided by provisioning 118 to opt subscribers in and out of the LBSMAP system. For example, a customer care interface can be an external opt-in agent that can access the APIs.

An important aspect of the disclosed systems and methods is that LBS service features can be implemented in real-time. For example, a mobile telephone user has an HLR entry that can be used to make a decision as to whether the subscriber is eligible for advertising subsidized communication service during call processing. A subscriber or user registered in the HLR may be associated with a global title that is modified in real-time to point a post-paid subscriber to the LBSMAP service instead of to the mobile operator or carrier when a low balance criteria is met. For example, a carrier may shut off a subscriber, or change the global title in the HLR, causing the subscriber to be redirected to the LBSMAP in real-time. The same type of operations may be implemented for pre-paid subscribers, so that advertising subsidized service can be provided to eligible subscribers without significant delay. A network configuration for implementing such a real-time system is described below.

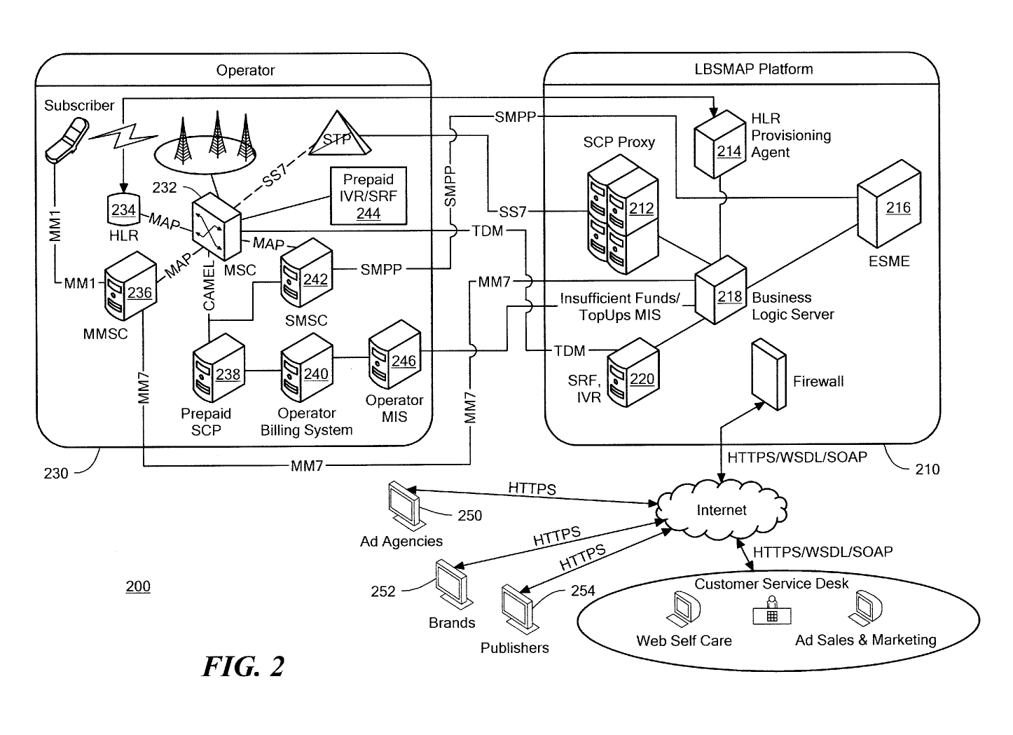

Referring now to FIG. 2, a physical architecture 200 illustrates a number of components of an LBSMAP platform 210 and an operator 230 in accordance with the present disclosure. LBSMAP platform 210 includes an SCP proxy 212, an HLR provisioning agent 214, an ESME 216, a business logic server 218 and an SRF/IVR 220. The components of LBSMAP platform 210 are typically implemented on computer servers that are or can be connected to each other to send and receive messages and signals to implement an advertising subsidized communication service in accordance with the present disclosure.

SCP proxy 212 performs various call processing related and advertising subsidization functions in accordance with the present disclosure. For example, SCP proxy 212 enables opt-in, performs call intercept and can provide voice ad injection for eligible subscribers or users on operator networks such as is provided by operator 230. SCP proxy 212 can perform these functions even where operator 230 does not use SCP proxy 212 as the primary SCP for a given call. However, SCP proxy 212 can become the service control point for call processing involving a subscriber that is indicated as being eligible for advertizing subsidized communication service by operator 230. Once a subscriber is eligible, SCP proxy 212 additionally checks whether an eligible subscriber has opted-in to LBS service, typically by being prompted through receipt of a text message or voice prompt, such as may be provided through SMS messaging or an IVR, respectively. Typically, subscribers that do not meet the threshold for LBS service, such as by maintaining a pre-paid balance or meeting carrier requirements for post-paid service are not directed to SCP proxy 212 for call processing. However, SCP proxy 212 operates as the initial contact point for LBS service once the criteria for advertising subsidized communication service is met in accordance with the operator configuration.

SCP proxy 212 need not be the primary intelligent network (IN) pre-paid SCP to perform one or more of the key functions of call intercept and voice ad injection for a given call. Operator 230 includes pre-paid SCP 238 that handles call processing for pre-paid subscribers in the general case. However, LBS traffic can be routed to SCP proxy 212 without interrupting the general functions of pre-paid SCP 238. These functions can occur without the provider of LBSMAP platform 210 being the primary IN SCP vendor of operator 230. This arrangement allows LBSMAP functions to be added without modifying the existing pre-paid back-end database structure or other components of the primary pre-paid rating and billing vendor or function.

LBSMAP platform 210 is configured to permit SCP proxy 212 to receive IN call signaling to initiate advertising subsidized communication service for pre-paid subscribers on a real-time basis. As discussed above, post-paid subscribers can be configured to utilize the LBS service by being represented as pre-paid subscribers by modifying HLR 234. The initiation of advertising subsidized communication service by SCP proxy 212 is implemented in real-time to permit subscribers to immediately take advantage of LBS service. SCP proxy 212 and business logic server 218 can keep a record of users of the LBS service to simplify transitions between normal pre-paid service and advertising subsidized service. In addition, SCP proxy 212 in conjunction with business logic server 218 can track trends or patterns in LBS usage to contribute to implementation of operator LBS service offerings, as well as ad plans designated by ad resources, such as ad agencies 250, brands 252 or publishers 254, for example.

According to one exemplary embodiment, the determination of whether a subscriber is eligible for LBS service is based on information provided in HLR 234, which is a real-time resource for mobile service subscribers. Upon being eligible, a message is provided to SCP proxy 212 to initiate advertising subsidized communication service. SCP proxy 212 emulates pre-paid SCP 238 in this respect, so that SCP proxy 212 and business logic server 218 and the other components of LBSMAP platform 210 complement and play the role of complement and perform roles otherwise performed by the pre-paid platform established by operator 230. If a subscriber is eligible for LBS service, and an LBS status is triggered, operator 230, or alternatively HLR provisioning agent 214, causes the global title for the subscriber to be modified in HLR 234, so that the subscriber is pointed to SCP proxy 212 instead of pre-paid SCP 238. Triggering for the LBS service can be implemented in real-time in embodiments where SCP proxy 212 is involved with handling the call or ad, as well as in embodiments where SCP proxy 212 is omitted or not involved in call or ad handling.

In one exemplary embodiment, SCP proxy 212 receives triggers when it is involved in call handling, and checks with pre-paid SCP 238 in relation to whether the subscriber has a sufficient or predetermined balance to permit a call to be made. The session control for the call can be undertaken by pre-paid SCP 238 or SCP proxy 212, or a combination of these components in complementary operation. The presence of SCP proxy 212 permits broad flexibility in implementing the ad-subsidized service of the presently disclosed system and method, since mobile operator 230 can use SCP proxy 212 to provide ad-subsidized service, while continuing to utilize SCP 238 as the primary SCP for prepaid services. Ad-subsidized service can be implemented flexibly, using SCP proxy 212 and/or pre-paid SCP 238 to handle call setup and control.

According to another exemplary embodiment, initiation of the LBS service can be implemented with LBSMAP platform 210 being lightly or heavily integrated with pre-paid SCP 238. For example, in addition to changes made to HLR 234, LBSMAP platform 210 can check with pre-paid SCP 238 to see if a minimum balance exists for the subscriber. Alternately, or in addition, a pre-paid balance in operator billing system 240 can be updated when the LBS service is initiated, potentially with a recognized value or cost for the ad-subsidized calls.

SCP proxy 212 provides call processing services in accordance with the configuration of LBSMAP platform 210 and the configuration for the subscriber. For example, business logic server 218 may provide instructions to SCP proxy 212 to permit another SCP to provide call processing for the subscriber. SCP proxy 212 can also be instructed to provide degraded call services, such as by permitting only incoming calls or shutting off a call connection after a certain period of time. Once a user is opted-in to the LBS service, they are added to a database housed in SCP proxy 212 or business logic server 218, where their use of LBS service is used to build a profile for the subscriber, that may be used to determine how a given ad plan is implemented for that subscriber. In this way, subscriber profiles can be categorized to meet certain qualifications of advertisers, such as by being high-volume callers, for example. A description of the actions for implementing the advertising subsidized communication service is described below.

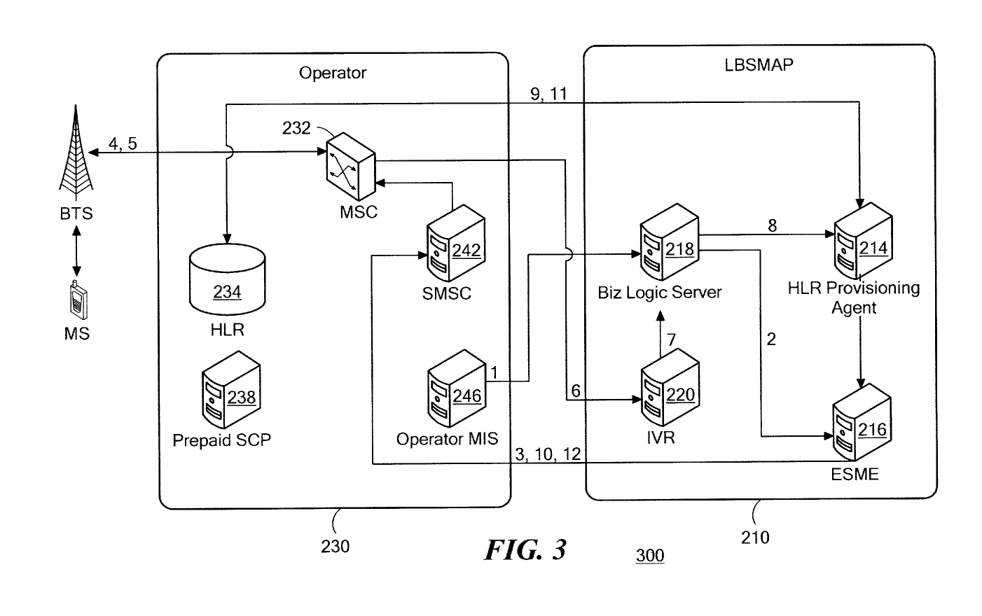

Referring now to FIG. 3, a process flow diagram 300 illustrates a notification and opt-in process for initiating LBS service with SCP proxy 212 enabled for call handling. The process flow begins with an operator MIS 240 providing a list of subscribers to business logic server 218 in LBSMAP 210. The subscriber list provided by operator MIS 246 can be delivered periodically, such as once an hour or more or less frequently. Business logic server 218 causes ESME 216 to provide an SMS text message to SMSC 242 in operator 230. The text message is delivered to the subscriber by SMSC 242 through MSC 232. The subscriber receives the text message and follows the instructions to contact IVR 220 through operator MSC 232. IVR 220 delivers voice messages to the subscriber with instructions on how to opt-in to the LBS service. Once the subscriber responds to IVR 220 with appropriate opt-in responses, IVR 220 notifies business logic server 218 of the opt-in request. Business logic server 218 can determine whether the opt-in request is satisfactory, or complies with the various business logic rules with which business logic server 218 is provisioned. If the opt-in request is validated at business logic server 218, a request is sent to HLR provisioning agent 214 to modify the SCP global title in HLR 234 to be directed to SCP proxy 212 for delivery of advertising subsidized communication service. HLR 234 initiates an SMS text message to the subscriber through SMSC 242 to indicate that the opt-in request is in progress. Once the modification is made to HLR 234 for the global title change, HLR provisioning agent 214 receives a confirmation from HLR 234. HLR provisioning agent 214 can then prompt ESME 216 to send an SMS text message to the subscriber through SMSC 242 to the effect that the opt-in request was successful, and that the subscriber can now make advertising subsidized calls.

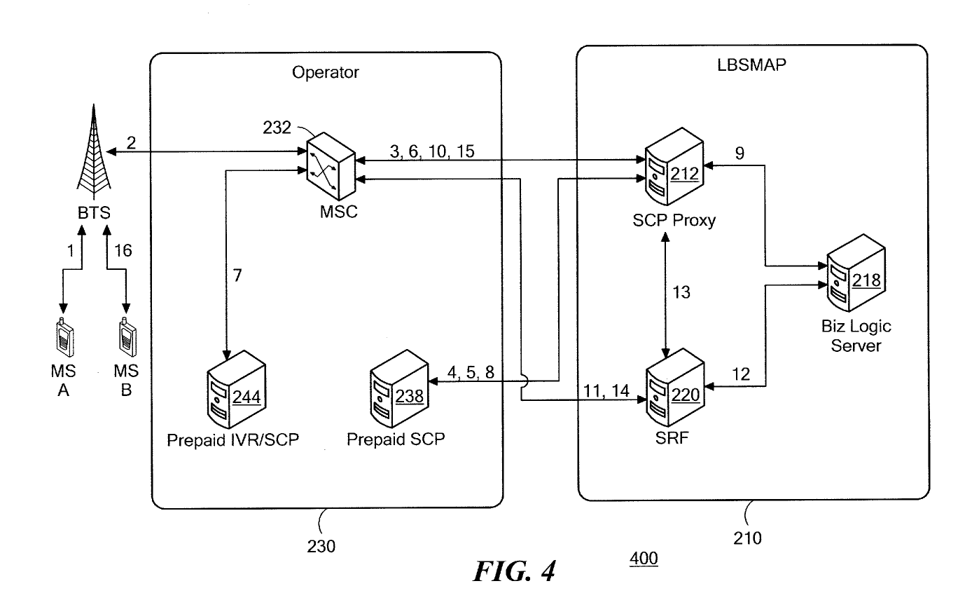

Referring now to FIG. 4, a process flow diagram 400 illustrates SCP proxy call handling process flow. The process illustrated in diagram 400 begins with a subscriber A, which has opted-in to the advertising subsidized service, placing a call to a user B. The call from subscriber A is received at MSC 232, which triggers a message to SCP proxy 212. SCP proxy 212 forwards the trigger to pre-paid SCP 238, which requests a connection to pre-paid IVR/SRF 244. Pre-paid IVR/SRF 244 provides subscriber A with a voice message to indicate that subscriber A has a low account balance, for example, and that the LBS service is potentially engaged. Pre-paid SCP 238 returns a message to SCP proxy 212 after the announcement is made to determine whether an ad is to be provided to subscriber A. For example, pre-paid SCP 238 may send a “disconnect from pre-paid SRF” request with a release call message to SCP proxy 212. In such a case, SCP proxy 212 understands that an advertisement is to be provided to subscriber A. In the event that pre-paid SCP 238 returns a message to SCP proxy 212 of “disconnect from pre-paid SRF” coupled with a “continue call processing” message, SCP proxy 212 forwards the message to MSC 232 without providing an advertisement to subscriber A.

When SCP proxy 212 receives a return message from pre-paid SCP 238 of “disconnect from pre-paid SRF,” and a release call message, SCP proxy 212 infers that the call by subscriber A is released due to a low balance situation. SCP proxy 212 can then check with business logic server 218 to determine if subscriber A is opted-in to the LBS service, and whether advertising subsidized calls are permitted. If it is determined that subscriber A is eligible to make advertising subsidized calls, SCP proxy 212 forwards the “disconnect from pre-paid SRF” request to MSC 232, followed by a request sent to MSC 232 to connect subscriber A to SRF 220. MSC 232 responds to the request by routing the call to SRF 220. SRF 220 interacts with business logic server 218 and SCP proxy 212 to select and deliver an advertisement to subscriber A over a delivery channel in accordance with a selected ad plan. The advertisement is delivered to subscriber A, after which SCP proxy 212 sends a “disconnect from SRF” request and a “connect to user B” request to MSC 232. MSC 232 receives the requests and connects subscriber A to user B. SCP proxy 212 monitors the call for a maximum call duration parameter, as may be imposed by the ad plan settings. SCP proxy 212 tears down the call from subscriber A to user B once a predetermined call duration is reached, and may take other steps such as decrementing a call counter maintained in a profile for subscriber A in LBSMAP 210.

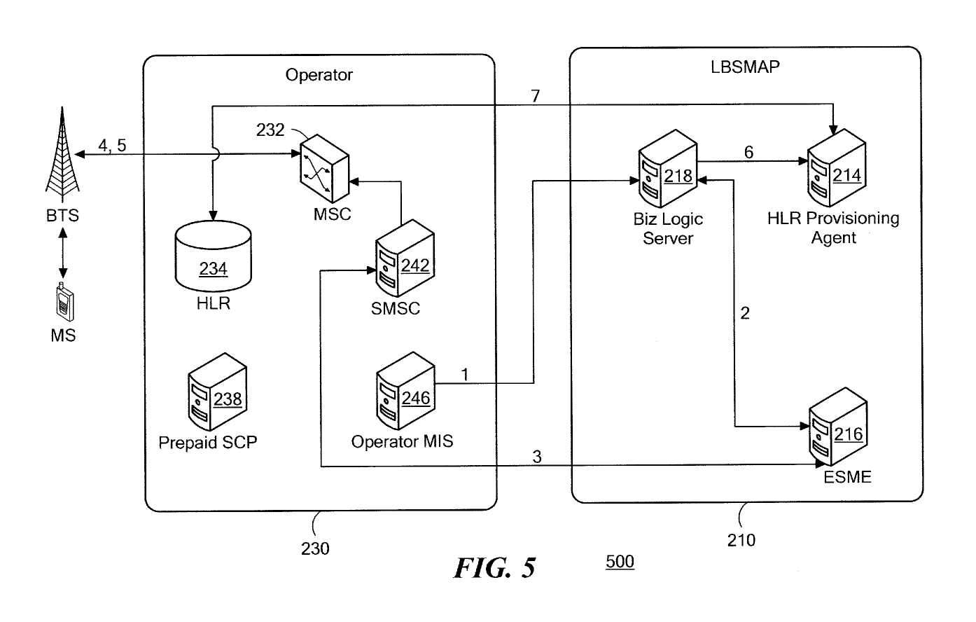

Referring now to FIG. 5, a process flow diagram 500 illustrates discontinuance of advertising supported service in accordance with the present disclosure. The process flow begins with operator MIS 246 providing a subscriber list to business logic server 218 on a periodic basis, such as every one or more hours. Business logic server 218 provides an SMS text message to the subscriber through ESME 216, SMSC 242 and MSC 232 to the effect that the subscriber is being discontinued for LBS services. Business logic server 218 sends a request to HLR provisioning agent 214 to change the SCP global title in HLR 234 to be directed to pre-paid SCP 238. HLR provisioning agent 214 provides the SCP global title change request to HLR 234, whereupon the subscriber is opted out of the advertising subsidized communication service.

The operations herein described are purely exemplary and imply no particular order. Further, the operations can be used in any sequence when appropriate and can be partially used. With the above embodiments in mind, it should be understood that the invention can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed system and method can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this invention. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the invention.

What is claimed is:

1. A system for providing an advertising subsidized communication service, comprising:
a service control point (SCP) that is responsive to messages from a mobile operator communication network to process a call by a user for an advertising subsidized communication service;
a business logic resource that is communicatively coupled to the SCP to provide a user status for receiving advertising subsidized communication service and to provide an advertising delivery configuration;
an advertising delivery mechanism that is communicatively coupled to the mobile operator communication network to deliver an ad through a communication channel indicated by the advertising delivery configuration; and
wherein the SCP is operative to cause the advertising delivery mechanism to deliver an ad associated with the call as indicated by the advertising delivery configuration when the user status indicates that the user is eligible for an advertising subsidized communication service.

2. The system according to claim 1, wherein the communication channel is a voice channel.

3. The system according to claim 2, wherein the ad delivery is achieved by intercepting a voice call and providing a voice message at a predetermined time in relation to when the voice call is made.

4. The system according to claim 1, wherein the communication channel is a text messaging channel.

5. The system according to claim 4, wherein the ad delivery is achieved by intercepting a text message and inserting the ad in the text message.

6. The system according to claim 1, wherein the SCP provides a message to the mobile operator communication network to identify the advertising delivery mechanism as an ad source, such that the mobile operator communication network can access the advertising delivery mechanism to permit delivery of the ad.

7. The system according to claim 1, wherein the SCP provides a message to the advertising delivery mechanism to cause the advertising delivery mechanism to deliver the ad associated with the call.

8. The system according to claim 1, further comprising an interactive voice response (IVR) component that is responsive to messages from the mobile operator communication network to indicate to the business logic resource that the user is eligible to receive advertising subsidized communication service.

9. The system according to claim 1, wherein the SCP is a pre-paid SCP in the mobile operator communication network.

10. The system according to claim 1, wherein the SCP is provided in a mobile advertising platform as a secondary SCP.

11. The system according to claim 10, further comprising a home location register (HLR) provisioning agent communicatively coupled to the business logic resource and being operative to provide a request to the mobile operator communication network to direct messages for processing the call by the user for the advertising subsidized communication service to the SCP.

12. The system according to claim 1, further comprising a text message origination resource communicatively coupled to the business logic resource and being operative to provide a text message to the mobile operator communication network for delivery to a destination indicated by the advertising delivery configuration provided by the business logic resource.

13. The system according to claim 1, further comprising a user interface communicatively coupled to the business logic resource to permit modification of the advertising delivery configuration.

14. The system according to claim 1, wherein the user is associated with one or more of a pre-paid or a postpaid account on the mobile operator communication network.

15. A computer implemented method for providing an advertising subsidized communication service, comprising:
providing an indication to a mobile communication device related to user eligibility for receiving advertising subsidized communication service;
receiving an indication from the mobile communication device to accept advertising subsidized communication service;
assigning an advertising delivery configuration to the mobile communication device;
receiving a signal related to a call involving the mobile communication device; and
providing an ad to a destination in accordance with the advertising delivery configuration.

16. The method according to claim 15, further comprising providing the ad via a voice channel.

17. The method according to claim 16, further comprising:
intercepting a voice call; and
providing a voice message at a predetermined time in relation to when the voice call is made.

18. The method according to claim 15, further comprising providing the ad via a text messaging channel.

19. The method according to claim 18, further comprising:
intercepting a text message; and
inserting the ad in the text message.

20. The method according to claim 15, further comprising providing a text message to the destination after the call ends.

21. The method according to claim 15, further comprising providing a message to a mobile operator communication network to indicate a resource that can provide the ad.

22. The method according to claim 15, further comprising providing a message to a resource that can provide the ad to deliver the ad in accordance with the advertising delivery configuration.

23. The method according to claim 15, further comprising providing a request to a mobile operator communication network to cause the signal related to the call involving the mobile communication device to be directed to a mobile advertising platform.

24. The method according to claim 15, wherein the mobile communication device is associated with either a pre-paid or post-paid account.

25. The method according to claim 15, further comprising:
receiving an indication of non-eligibility for receiving advertising subsidized communication service related to the mobile communication device; and
modifying the advertising delivery configuration to avoid providing an ad to the destination associated with the advertising delivery configuration.

26. A computer implemented method for providing an advertising subsidized communication service, comprising:
receiving a signal related to a call involving a pre-paid mobile communication device that is associated with an account with a balance below a predetermined threshold;
determining an ad to provide to a destination related to the pre-paid mobile communication device in accordance with business logic that describes advertising that is available to the pre-paid communication device; and
providing the ad to the destination.
